(19) United States
(12) Patent Application Publication
(10) Pub. No.: US 2017/0162870 A1
(43) Pub. Date: Jun. 8, 2017

(54) CATHODE COMPOSITE MATERIAL, LITHIUM ION BATTERY USING THE SAME AND METHOD FOR MAKING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Guan-Nan Qian, Suzhou (CN); Xiang-Ming He, Beijing (CN); Li Wang, Beijing (CN); Yu-Ming Shang, Beijing (CN); Jian-Jun Li, Beijing (CN); Zhen Liu, Beijing (CN); Jian Gao, Beijing (CN); Hong-Sheng Zhang, Suzhou (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/442,507

(22) Filed: Feb. 24, 2017

Related U.S. Application Data
(63) Continuation of application No. PCT/CN2015/082716, filed on Jun. 30, 2015.

(30) Foreign Application Priority Data
Aug. 26, 2014 (CN) 201410424572.2

(51) Int. Cl. H01M 4/36; H01M 4/62; H01M 10/0525

(52) U.S. Cl. CPC H01M 4/366; H01M 10/0525; H01M 4/62; H01M 2004/028

(57) ABSTRACT

A method for making a cathode composite material is disclosed. The method comprises: providing a maleimide type material, wherein the maleimide type material is selected from the group consisting of a maleimide type monomer, a polymer formed from the maleimide type monomer, and combinations thereof; mixing the maleimide type material with a cathode active material uniformly to form a mixture; heating the mixture at a temperature of about 200° C. to about 280° C. in a protective gas to obtain the cathode composite material. The cathode composite material, and a lithium ion battery using the same are also disclosed.

### CROSS-REFERENCE TO RELATED APPLICATIONS

This application claims all benefits accruing under 35 U.S.C. §119 from China Patent Application No. 201410424572.2, filed on Aug. 26, 2014 in the State Intellectual Property Office of China, the content of which is hereby incorporated by reference. This application is a continuation under 35 U.S.C. §120 of international patent application PCT/CN2015/082716 filed on Jun. 30, 2015, the content of which is also hereby incorporated by reference.

### FIELD

The present disclosure relates to cathode composite materials, and methods for making the same. The present disclosure further relates to lithium ion batteries using the cathode composite materials, and methods for making the same.

### BACKGROUND

In recent years, with the widespread application of lithium ion batteries in mobile phones, laptops, and electric vehicles etc., the safety of the lithium ion batteries has aroused extensive attention from the public. In the China Patent Application Publication No. CN101807724A, Wu et al. discloses a lithium ion battery which is able to guard against thermal runaway. A maleimide is polymerized with a barbituric acid at low temperature (such as 130° C.) to form a polymer/oligomer with low average molecular weight, and a protective film is formed by coating the polymer/oligomer on a surface of an electrode active material. Wu et al. believes that the polymer/oligomer can be crosslinked with each other when the temperature of the lithium ion battery is increased, which has a lockdown effect to block transportation of the lithium ions to avoid thermal runaway.

### BRIEF DESCRIPTION OF THE DRAWINGS

Implementations are described by way of example only with reference to the attached figures.

FIG. 1 shows a transmission electron microscopy (TEM) photo of one embodiment of a cathode composite material.

FIG. 2 is a graph showing cycling performance of one embodiment of the cathode composite material in a lithium ion battery.

### DETAILED DESCRIPTION

A detailed description with the above drawings is made to further illustrate the present disclosure.

In one embodiment, a method for making a cathode composite material comprises:

S1, providing a maleimide type material, wherein the maleimide type material can be selected from a maleimide type monomer, a polymer formed from the maleimide type monomer, and combinations thereof;

S2, mixing the maleimide type material with a cathode active material uniformly to form a first mixture; and

S3, heating the first mixture at a temperature of about 200° C. to about 280° C. in a protective gas to obtain the cathode composite material.

The maleimide type material can be the polymer formed from the maleimide type monomer. The maleimide type monomer can comprise at least one of a maleimide monomer, a bismaleimide monomer, a multimaleimide monomer, and a maleimide type derivative monomer.

The maleimide monomer can be represented by formula I:

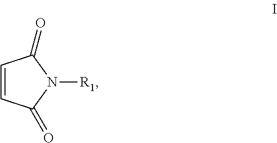

wherein R₁ can be a monovalent organic substituent. R₁ can be —R, —RNH₂R, —C(O)CH₃, —CH₂OCH₃, —CH₂S(O)CH₃, monovalent alicyclic group, monovalent substituted aromatic group, or monovalent unsubstituted aromatic group, such as —C₆H₅, —C₆H₄C₆H₅, or —CH₂(C₆H₄)CH₃. R can be a hydrocarbyl having 1 to 6 carbon atoms, such as an alkyl having 1 to 6 carbon atoms. An atom, such as hydrogen, of a monovalent aromatic group can be substituted by a halogen, an alkyl having 1 to 6 carbon atoms, or a silane group having 1 to 6 carbon atoms to form the monovalent substituted aromatic group. The monovalent unsubstituted aromatic group can be phenyl, methyl phenyl, or dimethyl phenyl. An amount of benzene ring in the monovalent substituted aromatic group or the monovalent unsubstituted aromatic group can be 1 to 2.

The maleimide monomer can be selected from N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

The bismaleimide monomer can be represented by formula II or formula III:

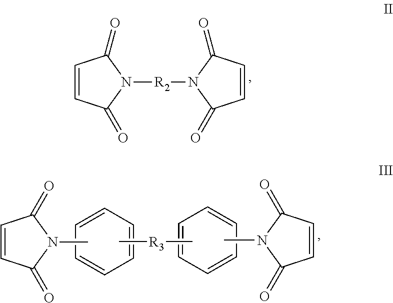

wherein R₂ can be a bivalent organic substituent. R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, bivalent alicyclic group, bivalent substituted aromatic group, or bivalent unsubstituted aromatic group, such as phenylene (—C₆H₄—), diphenylene (—C₆H₄C₆H₄—), substituted phenylene, substituted diphenylene, —(C₆H₄)—R₃—(C₆H₄)—, —CH₂(C₆H₄)CH₂—, or —CH₂(C₆H₄)(O)—. R₃ can be —CH₂—, —C(O)—, —C(CH₃)₂, —O—, —O—O—, —S—, —S—S—, —S(O)—, or —(O)S(O)—. R can be a hydrocarbyl having 1 to 6 carbon atoms, such as an alkyl having 1 to 6 carbon atoms. An atom, such as hydrogen, of a bivalent aromatic group can be substituted by a halogen, an alkyl having 1 to 6 carbon atoms, or a silane group having 1 to 6 carbon atoms to form the bivalent substituted aromatic group. An amount of benzene ring in the bivalent substituted aromatic group or the bivalent unsubstituted aromatic group can be 1 to 2.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

The maleimide type derivative monomer can be obtained by substituting a hydrogen atom of the maleimide monomer, the bismaleimide monomer, or the multimaleimide monomer with a halogen atom.

In S1, a method for making the polymer can comprise: dissolving and mixing a barbituric acid type compound and the maleimide type monomer in a first organic solvent to form a first solution; and heating and stirring the first solution at a temperature of about 100° C. to about 150° C. to obtain the polymer.

A molar ratio of the barbituric acid type compound to the maleimide type monomer can be in a range from about 1:1 to about 1:20, such as about 1:3 to about 1:10. The first organic solvent can be at least one of N-methyl pyrrolidone (NMP), gamma-butyrolactone, propylene carbonate, dimethylformamide, and dimethylacetamide. The barbituric acid type compound can be mixed with the maleimide type monomer in the first organic solvent. The first solution can be heated to the temperature of about 100° C. to about 150° C., such as about 130° C., and then stirred constantly to react adequately. A reaction time of the first solution depends on amounts of reactants, and can be in a range from about 1 hour to 72 hours.

The barbituric acid type compound can be a barbituric acid or a derivative of the barbituric acid. The barbituric acid type compound can be represented by formula IV, formula V, formula VI or formula VII:

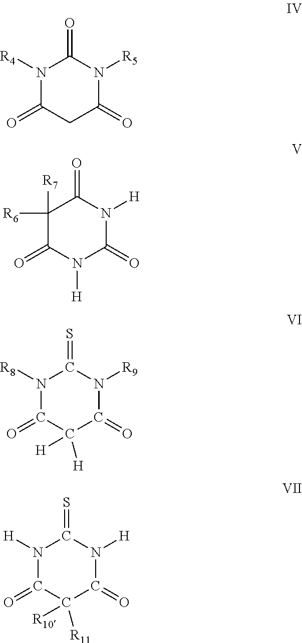

wherein R₄, R₅, R₆, R₇, R₈, R₉, R₁₀, and R₁₁ can be the same or different substituent groups, such as H, CH₃, C₂H₅, C₆H₅, CH(CH₃)₂, CH₂CH(CH₃)₂, CH₂CH₂CH(CH₃)₂, or

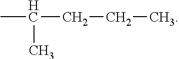

When R₄, R₅, R₆, and R₇ are both hydrogen atom, the formula IV and formula V are barbituric acid.

The polymer is formed from the maleimide type monomer at the low temperature of about 100° C. to about 150° C., and has a low molecular weight of about 200 to about 2999.

In S2, a mass ratio of the maleimide type material to the cathode active material can be in a range from about 1:9999 to about 5:95.

In one embodiment, the maleimide type material can be pre-dispersed in a second organic solvent. For example, the maleimide type material can be dissolved in the second organic solvent to form a second solution. The cathode active material can be added to the second solution, and uniformly mixed with the maleimide type material by stirring or ultrasonic vibration. A mass ratio of the second solution to the cathode active material can be in a range from about 1:1 to about 1:10, such as about 1:1 to about 1:4. A mass percentage of the maleimide type material in the second solution can be in a range from about 1% to about 5%.

In another embodiment, the maleimide type material, the cathode active material, and the second organic solvent can be mixed with each other at the same time. An amount of the second organic solvent can be strictly controlled, thereby the mixing of the maleimide type material and the cathode active material can be substantially regarded as a solid-solid mixing. And ways such as grinding or ball-milling can be used to have a uniform mixing. A mass percentage of the second organic solvent can be in a range from about 0.01% to about 10%.

The second organic solvent can be removed by vacuum drying (e.g. at a temperature of about 50° C. to about 80° C.) after mixing of the maleimide type material and the cathode active material. The second organic solvent can be at least one of gamma-butyrolactone, propylene carbonate, and N-methyl pyrrolidone (NMP).

In another embodiment, the maleimide type monomer and the cathode active material can be mixed in the first organic solvent to form a second mixture. The barbituric acid type compound can be then added to the second mixture, stirred, and heated at the temperature of about 100° C. to about 150° C. to form the polymer directly on a surface of the cathode active material.

In S3, when the maleimide type material comprises the maleimide type monomer, a cross-linked polymer with high molecular weight can be directly formed from the maleimide type monomer at the temperature of about 200° C. to about 280° C. in the protective gas. When the maleimide type material comprises the polymer with low molecular weight formed from the maleimide type monomer, the cross-linked polymer with high molecular weight can be formed by crosslinking the polymer with low molecular weight with each other at the temperature of about 200° C. to about 280° C. in the protective gas. The test results show that when the maleimide type monomer and the barbituric acid type compound are reacted at the temperature of about 100° C. to about 150° C., the obtained polymer with low molecular weight can be dissolved in the first organic solvent, and when the polymer with low molecular weight is further heated to the temperature of about 200° C. to about 280° C., the obtained cross-linked polymer with high molecular weight cannot be dissolved in the first organic solvent. An average molecular weight of the cross-linked polymer can be in a range from about 5000 to about 50000.

The cross-linked polymer can be uniformly mixed with the cathode active material. The cross-linked polymer can be coated on the surface of the cathode active material to form a core-shell structure. The protective gas can be nitrogen gas or an inert gas.

In one embodiment, after being heated at the temperature of about 200° C. to about 280° C., the first mixture can be heated at a lower temperature of about 160° C. to about 190° C. for a period of time, so that a more uniform coating can be formed due to a homogeneous solidification of the cross-linked polymer.

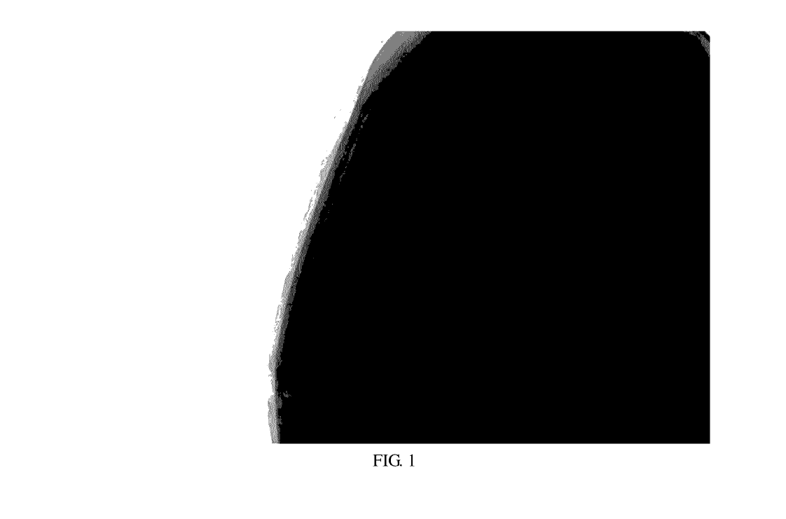

The cathode composite material comprises the cathode active material and the cross-linked polymer combined with the cathode active material. The cross-linked polymer can be obtained by heating the maleimide type material at the temperature of about 200° C. to about 280° C. in the protective gas. The cross-linked polymer can be uniformly mixed with the cathode active material. The cross-linked polymer can be coated on the surface of the cathode active material to form the core-shell structure. Referring to FIG. 1, a thickness of the coating of the cross-linked polymer can be about 5 nm to about 100 nm, such as about 30 nm. A mass percentage of the cross-linked polymer in the cathode composite material can be in a range from about 0.01% to about 5%, such as about 0.1% to about 2%. The maleimide type material can be selected from the maleimide type monomer, the polymer with low molecular weight formed from the maleimide type monomer, and combinations thereof.

The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The cathode composite material can comprise a conducting agent and/or a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR).

In one embodiment, a method for making a lithium ion battery comprises: obtaining the cathode composite material by the above described method; disposing the cathode composite material on a surface of a cathode current collector to form a cathode; and assembling a lithium ion battery by using the cathode, an anode, a separator, and an electrolyte liquid.

The lithium ion battery comprises the cathode, the anode, the separator, and the electrolyte liquid. The cathode and the anode can be spaced from each other by the separator. The cathode can further comprise the cathode current collector and the cathode composite material located on the surface of the cathode current collector. The anode can further comprise an anode current collector and an anode material located on a surface of an anode current collector. The anode material and the cathode composite material are relatively arranged and spaced by the separator.

The anode material can comprise an anode active material, and can further comprise a conducting agent and a binder. The anode active material can be at least one of lithium titanate, graphite, mesophase carbon micro beads (MCMB), acetylene black, mesocarbon miocrobead, carbon fibers, carbon nanotubes, and cracked carbon. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane having nylon fabric and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF6), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### Examples

### Example 1

An N-phenyl maleimide monomer and a barbituric acid with a molar ratio of about 2:1 are dissolved and mixed in NMP to form a solution. The solution is stirred and heated at 130° C. for 24 hours, and cooled to obtain a polymer 1. The polymer 1 is then precipitated in ethanol, washed, and dried.

1 g of the polymer 1 is uniformly dispersed in 299 g of a ternary cathode active material (LiNi_{1/3}Co_{1/3}Mn_{1/3}O₂). A small amount of NMP is added to dissolve the polymer 1. The mixture is milled for 2 hours. After being dried at 70° C., the mixture is put in a heating furnace, heated to 240° C. at a heating rate of 1° C./min and kept at 240° C. for 1 hour, and then cooled to 180° C. and kept at 180° C. for 1 hour in nitrogen gas. After being cooled to the room temperature, a product 1 is obtained.

Half Cell

80% of the product 1, 10% of PVDF, and 10% of conducting graphite by mass percent are mixed and dispersed by NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

Full Cell

94% of the product 1, 3% of PVDF, and 3% of conducting graphite by mass percent are mixed and dispersed by NMP to form a slurry. The slurry is coated on an aluminum foil, vacuum dried at about 120° C., pressed and cut to obtain a cathode.

94% of graphite anode, 3.5% of PVDF, and 2.5% of conducting graphite by mass percent are mixed and dispersed by NMP to form a slurry. The slurry is coated on a copper foil, vacuum dried at about 100° C., pressed and cut to obtain an anode.

1 M of LiPF₆ is dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

### Example 2

A bismaleimide (BMI) monomer and a barbituric acid with a molar ratio of about 2:1 are dissolved and mixed in NMP to form a solution. The solution is stirred and heated at 130° C. for 24 hours, and cooled to form a polymer 2. Then the polymer 2 is precipitated in ethanol, washed and dried.

4.8 g of the polymer 2 is uniformly dispersed in 297 g of a ternary cathode active material (LiNi_{1/3}Co_{1/3}Mn_{1/3}O₂). A small amount of NMP is added to dissolve the polymer 2. The mixture is milled for 2 hours. After being dried at 70° C., the mixture is put in a heating furnace, heated to 260° C. at a heating rate of 1° C./min and kept at 260° C. for 1 hour, and then cooled to 180° C. and kept at 180° C. for 1 hour in nitrogen gas. After being cooled to the room temperature, a product 2 is obtained.

Full Cell

94% of the product 2, 3% of PVDF, and 3% of conducting graphite by mass percent are mixed and dispersed by NMP to form a slurry. The slurry is coated on an aluminum foil, vacuum dried at about 120° C., pressed and cut to obtain a cathode.

94% of graphite anode, 3.5% of PVDF, and 2.5% of conducting graphite by mass percent are mixed and dispersed by NMP to form a slurry. The slurry is coated on a copper foil, vacuum dried at about 100° C., pressed and cut to obtain an anode.

1 M of LiPF₆ is dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

### Example 3

A bismaleimide monomer represented by formula VIII and a barbituric acid with a molar ratio of about 2:1 are dissolved and mixed in NMP to form a solution. The solution is then stirred and heated at 130° C. for 24 hours, and cooled to form a polymer 3. The polymer 3 is precipitated in ethanol, washed and dried.

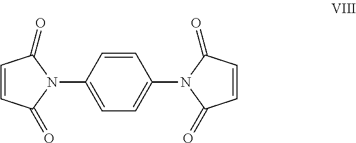 [SMILES: O=C1C=CC(=O)N1c1ccc(N2C(=O)C=CC2=O)cc1]

3 g of the polymer 3 is uniformly dispersed in 297 g of a ternary cathode active material (LiNi_{1/3} Co_{1/3}Mn_{1/3}O₂). A small amount of NMP is added to dissolve the polymer 3. The mixture is milled for 2 hours. After being dried at 70° C., the mixture is put in a heating furnace, heated to 280° C. at a heating rate of 1° C./min and kept at 280° C. for 1 hour, and then cooled to 180° C. and kept at 180° C. for 1 hour in nitrogen gas. After being cooled to the room temperature, a product 3 is obtained.

Full Cell

94% of the product 3, 3% of PVDF, and 3% of conducting graphite by mass percent are mixed and dispersed by NMP to form a slurry. The slurry is coated on an aluminum foil, vacuum dried at about 120° C., pressed and cut to obtain a cathode.

94% of graphite anode, 3.5% of PVDF, and 2.5% of conducting graphite by mass percent are mixed and dispersed by NMP to form a slurry. The slurry is coated on a copper foil, vacuum dried at about 100° C., pressed and cut to obtain an anode.

1 M of LiPF₆ is dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

### Comparative Example 1

Half Cell

80% of ternary cathode active material (LiNi_{1/3} Co_{1/3}Mn_{1/3}O₂), 10% of PVDF, and 10% of conducting graphite by mass percent are mixed and dispersed by NMP to form a slurry. The slurry is coated on an aluminum foil, and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

Full Cell

94% of ternary cathode active material (LiNi_{1/3} Co_{1/3}Mn_{1/3}O₂), 3% of PVDF, and 3% of conducting graphite by mass percent are mixed and dispersed by NMP to form a slurry. The slurry is coated on an aluminum foil, vacuum dried at about 120° C., pressed and cut to obtain a cathode.

94% of graphite anode, 3.5% of PVDF, and 2.5% of conducting graphite by mass percent are mixed and dispersed by NMP to form a slurry. The slurry is coated on a copper foil, vacuum dried at about 100° C., pressed and cut to obtain an anode.

1 M of LiPF₆ is dissolved in a solvent mixture of EC/DEC/EMC=1/1/1(v/v/v) to obtain an electrolyte liquid. The cathode and the anode are assembled and rolled up to form a 63.5 mm×51.5 mm×4.0 mm sized soft packaged battery.

The full cells of Example 1 to 3 and Comparative Example 1 are overcharged at a current rate of 1 C to a cut-off voltage of 10 V. The highest temperature of the full cells of Example 1 to 3 is about 93° C., and the full cells do not show significant deformation in the overcharging process. However, the full cell of Comparative Example 1 bursts into flames when it is overcharged to 8 V, and the temperature thereof is up to 500° C.

TABLE 1
Overcharge Test Data of Full Cells of Examples 1 to 3
and Comparative Example 1

| | Highest temperature | |
|---|---|---|
| | (° C.) | Overcharge phenomenon |
| Example 1 | 93° C. | No significant deformation |
| Example 2 | 89° C. | No significant deformation |
| Example 3 | 84° C. | No significant deformation |
| Comparative | 500° C. | Burning |
| Example 1 | | |

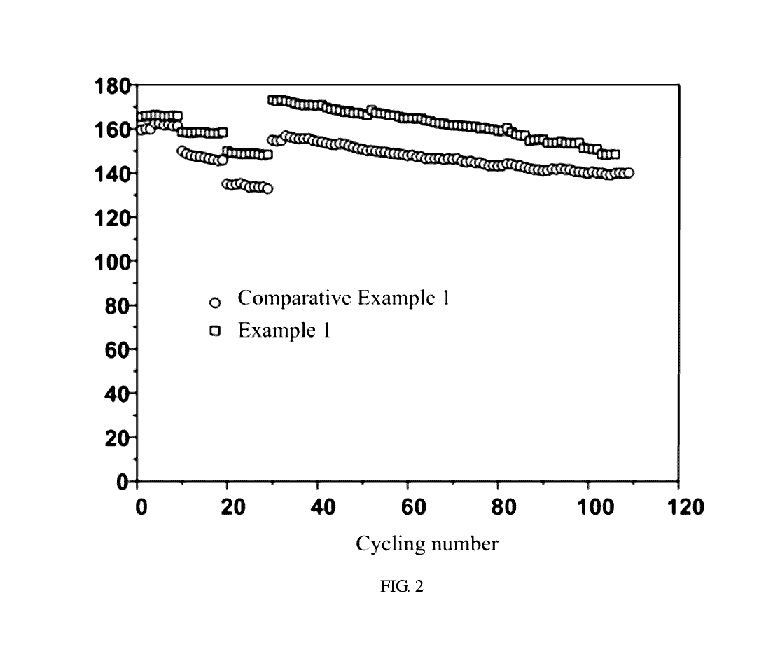

The half cells of Example 1 and Comparative Example 1 are charged and discharged at a constant current rate of 0.2 C, 0.5 C, and 1 C respectively in a voltage ranged from 2.8 V to 4.3 V for 10 cycles, and then charged and discharged at a constant current rate of 1 C in a voltage ranged from 2.8 V to 4.5 V. FIG. 2 is a graph showing cycling performances of Example 1 and Comparative example 1 of the half cells. It can be seen from FIG. 2 that the half cell adding the product 1 has better electrochemical performance, higher capacity, and better cycling stability at high current and high voltage.

Different from the forming of the cross-linked polymer from the polymer with low molecular weight only when the lithium ion battery is overheated, in the present disclosure the cross-linked polymer formed at the temperature of about 200° C. to about 280° C. in the protective gas is directly coated on the surface of the cathode active material. Experiments have shown that the cross-linked polymer does not block transportation of the lithium ions, the lithium ions can still intercalate to or deintercalate from the cathode active material through the cross-linked polymer, and the lithium ion battery using the cross-linked polymer can still work well. The excellent safety performance of the lithium ion battery in the present disclosure is not caused by the blocking of the transportation of the lithium ions, but due to the blocking of an interface reaction between the cathode active material and the electrolyte liquid by the cross-linked polymer at high voltage. Without the cross-linked polymer, the heat generated by the interface reaction would initiate more interface reaction, and then more heat would be generated, which would lead to concentration of too much heat, and decrease the safety of the lithium ion battery. The cross-linked polymer directly coated on the surface of the cathode active material can interrupt or restrain the occurrence of the interface reaction at the beginning to avoid thermal runaway due to heat concentration.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for making a cathode composite material, comprising:
providing a maleimide type material, wherein the maleimide type material is selected from the group consisting of a maleimide type monomer, a polymer formed from the maleimide type monomer, and combinations thereof;
mixing the maleimide type material with a cathode active material uniformly to form a mixture; and
heating the mixture at a temperature of about 200° C. to about 280° C. in a protective gas.

2. The method of claim 1, wherein the maleimide type monomer is selected from the group consisting of maleimide monomer, bismaleimide monomer, multimaleimide monomer, maleimide type derivative monomer, and combinations thereof.

3. The method of claim 2, wherein the maleimide monomer is represented by formula I: 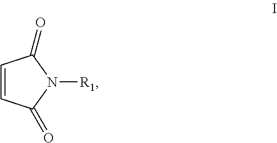
wherein R₁ is a monovalent organic substitute.

4. The method of claim 3, wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, and a monovalent alicyclic group; and R is a hydrocarbyl having 1 to 6 carbon atoms.

5. The method of claim 2, wherein the maleimide monomer is selected from the group consisting of N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

6. The method of claim 2, wherein the bismaleimide monomer is represented by formula II or formula III: 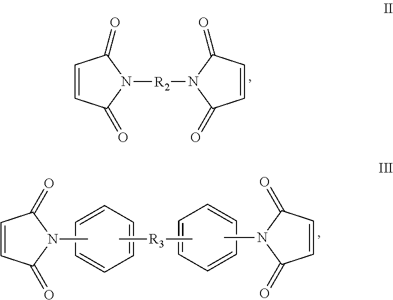
wherein R₂ is a bivalent organic substitute.

7. The method of claim 6, wherein R₂ is selected from the group consisting of —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, a bivalent alicyclic group and —(C₆H₄)—R₃—(C₆H₄)—; R₃ is selected from the group consisting of —CH₂—, —C(O)—, —C(CH₃)₂—, —O—, —O—O—, —S—, —S—S—, —S(O)—, or —(O)S(O)—; and R is a hydrocarbyl having 1 to 6 carbon atoms.

8. The method of claim 2, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

9. The method of claim 1, wherein a molecular weight of the polymer formed from the maleimide type monomer is in a range from about 200 to about 2999.

10. The method of claim 1, wherein the polymer is formed by: dissolving and mixing a barbituric acid type compound and the maleimide type monomer in an organic solvent to form a solution; and heating and stirring the solution at a temperature of about 100° C. to about 150° C.

11. The method of claim 1, wherein a mass ratio of the maleimide type material to the cathode active material is in a range from about 1:9999 to about 5:95.

12. The method of claim 1, wherein the protective gas is nitrogen gas or an inert gas.

13. A cathode composite material, comprising a cathode active material and a cross-linked polymer combined with the cathode active material, wherein the cross-linked polymer is obtained by heating a maleimide type material at a temperature of about 200° C. to about 280° C. in a protective gas, and the maleimide type material is selected from the group consisting of a maleimide type monomer, a polymer formed from the maleimide type monomer, and combinations thereof.

14. The cathode composite material of claim 13, wherein the cross-linked polymer is coated on a surface of the cathode active material to form a core-shell structure.

15. The cathode composite material of claim 14, wherein a thickness of a coating of the cross-linked polymer is in a range from about 5 nm to about 100 nm.

16. The cathode composite material of claim 13, wherein a molecular weight of the cross-linked polymer is in a range from about 5000 to about 50000.

17. A lithium ion battery, comprising a cathode, an anode, a separator, and an electrolyte liquid, wherein the cathode comprises a cathode composite material; the cathode composite material comprises a cathode active material and a cross-linked polymer combined with the cathode active material; the cross-linked polymer is obtained by heating a maleimide type material at a temperature of about 200° C. to about 280° C. in a protective gas; and the maleimide type material is selected from the group consisting of a maleimide type monomer, a polymer formed from the maleimide type monomer, and combinations thereof.

18. The lithium ion battery of claim 17, wherein the cross-linked polymer is coated on a surface of the cathode active material to form a core-shell structure.

19. The lithium ion battery of claim 18, wherein a thickness of a coating of the cross-linked polymer is in a range from about 5 nm to about 100 nm.

20. The lithium ion battery of claim 17, wherein a molecular weight of the cross-linked polymer is in a range from about 5000 to about 50000.
